(19) United States
(12) Patent Application Publication
(10) Pub. No.: US 2019/0362014 A1
(43) Pub. Date: Nov. 28, 2019

(54) METHOD AND DEVICE FOR MANAGING BIG-DATA IN CLOUD ENVIRONMENT

(71) Applicant: Wipro Limited, Bangalore (IN)

(72) Inventor: Sheikh Ikhlaq, Srinagar (IN)

(21) Appl. No.: 16/035,225

(22) Filed: Jul. 13, 2018

(30) Foreign Application Priority Data
May 28, 2018 (IN) 201841019866

(51) Int. Cl. G06F 17/30

(52) U.S. Cl. CPC G06F 17/30563; G06F 17/30958; G06F 17/30339; G06F 17/30569

(57) ABSTRACT

A method and device for managing Big-Data in a cloud environment is disclosed. The method includes receiving a plurality of data from a plurality of data sources into a data warehouse, wherein the plurality of data comprises at least one of structured and unstructured data. The method further includes storing the plurality of data in a plurality of data clouds, wherein structured data is stored in structured sections of a data cloud and unstructured data is stored in unstructured sections of the data cloud. The method includes creating a cloud map table comprising storage details associated with the plurality of data stored on the plurality of data clouds. The method further includes retrieving at least one of the plurality of data stored on the plurality of data clouds based on the cloud map table, in response to a data retrieval query generated by a user.

This application claims the benefit of Indian Patent Application Serial No. 201841019866, filed May 28, 2018, which is hereby incorporated by reference in its entirety.

### FIELD

This disclosure relates generally to Big-Data and more particularly to methods and devices for managing Big-Data in cloud environments.

### BACKGROUND

There are various technologies to process Big-Data. However, the main problem to implement these technologies is that of cost and scalability. Another major problem being faced by these technologies is that they do not support proper data management. Data is scattered all around, which makes it very difficult to process and attain desired results with agility. Processing of this data with respect to data mining and machine learning is not achievable as none of the present technologies work with technologies of Big-Data processing. One of the major problems encountered while implementing Big-Data technologies is the lack of proper data management. There is no data management technique that does not give rise to other problems, for example, data virtualization, network intrusion, security, ease of use, and query support. Moreover, existing Big-Data technologies do not provide any support for multidimensional view of data. In other words, the existing technologies fail to create or find relations, co-relation, and patterns in data.

One of the best ways to manage Big-Data may be found in the concept of data warehousing. A data warehouse integrates large amounts of enterprise data from various and independent data sources consisting of operational databases into a common repository for querying and analyzing. Once assembled, the data warehouse may be made available to end users, who can use it to support a plethora of different kinds of business decision support and information collection activities. However, the data is generally not in the correct format to support a decision-making process in a business and therefore curation of the data is required in order to make it available in a format that facilitates decision making mechanisms.

Traditional data warehousing of data is however not helpful when it comes to addressing Big-Data, owing to the increasing complexity of the data and the sheer volume of data which needs to be computed.

### SUMMARY

In one embodiment, a method for managing Big-Data in a cloud environment is disclosed. The method includes receiving, by a data management device, a plurality of data received from a plurality of data sources into a data warehouse, wherein the plurality of data comprises at least one of structured and unstructured data. The method further includes storing, by the data management device, the plurality of data in a plurality of data clouds, wherein each of the plurality of data clouds is divided into a structured section and an unstructured section, wherein structured data is stored in the structured section of a data cloud and unstructured data is stored in the unstructured section of the data cloud. The method includes creating, by the data management device, a cloud map table comprising storage details associated with the plurality of data stored on the plurality of data clouds. The method further includes retrieving, by the data management device, at least one of the plurality of data stored on the plurality of data clouds based on the cloud map table, in response to a data retrieval query generated by a user.

In another embodiment, a data management device for managing Big-Data in a cloud environment is disclosed. The data management device includes a processor and a memory communicatively coupled to the processor, wherein the memory stores processor instructions, which, on execution, causes the processor to receive a plurality of data received from a plurality of data sources into a data warehouse, wherein the plurality of data comprises at least one of structured and unstructured data. The processor instructions further cause the processor to store the plurality of data in a plurality of data clouds, wherein each of the plurality of data clouds is divided into a structured section and an unstructured section, wherein structured data is stored in the structured section of a data cloud and unstructured data is stored in the unstructured section of the data cloud. The processor instructions cause the processor to create a cloud map table comprising storage details associated with the plurality of data stored on the plurality of data clouds. The processor instructions further cause the processor to retrieve at least one of the plurality of data stored on the plurality of data clouds based on the cloud map table, in response to a data retrieval query generated by a user.

In yet another embodiment, a non-transitory computer-readable storage medium is disclosed. The non-transitory computer-readable storage medium has instructions stored thereon, a set of computer-executable instructions causing a computer comprising one or more processors to perform steps comprising receiving a plurality of data received from a plurality of data sources into a data warehouse, wherein the plurality of data comprises at least one of structured and unstructured data; storing the plurality of data in a plurality of data clouds, wherein each of the plurality of data clouds is divided into a structured section and an unstructured section, wherein structured data is stored in the structured section of a data cloud and unstructured data is stored in the unstructured section of the data cloud; creating a cloud map table comprising storage details associated with the plurality of data stored on the plurality of data clouds; and retrieving at least one of the plurality of data stored on the plurality of data clouds based on the cloud map table, in response to a data retrieval query generated by a user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for managing Big-Data in a cloud environment, in accordance with an embodiment.

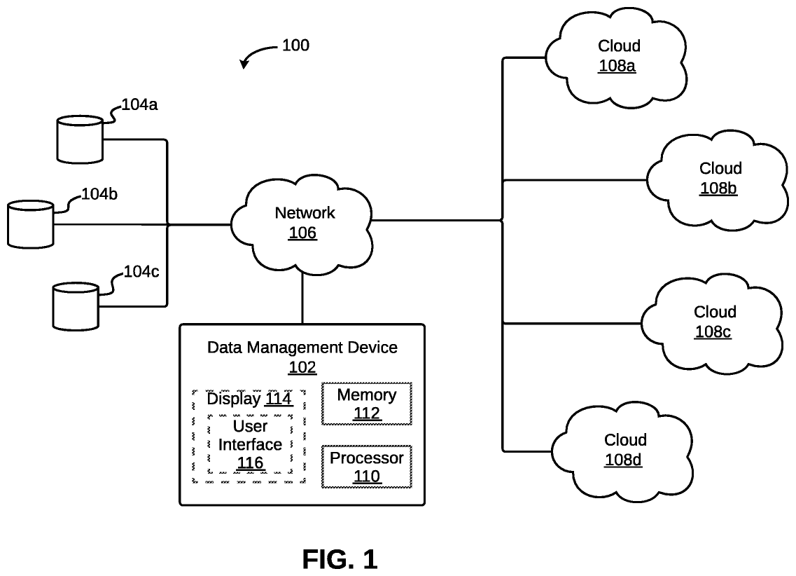

FIG. 2 is a block diagram illustrating various modules within a memory of a data management device configured manage Big-Data in a cloud environment, in accordance with an embodiment.

FIG. 3 illustrates a flowchart of a method for managing Big-Data in a cloud environment, in accordance with an embodiment.

FIG. 4 illustrates a flowchart of a method for managing Big-Data in a cloud environment, in accordance with another embodiment.

FIG. 5 illustrates a data map table storing address for data stored in a plurality of data clouds, in accordance with an exemplary embodiment.

FIG. 6 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Additional illustrative embodiments are listed below. In one embodiment, a system 100 for managing Big-Data in a cloud environment is illustrated, in accordance with an embodiment. System 100 incudes a data management device 102, which for example, may be one of a server, a computing device, an application server, or a gateway. Examples of the computing device, may include, but are not limited to a laptop, a desktop, a smart phone, or a tablet.

Data management device 102 may be communicatively coupled to a plurality of data sources 104 (which includes a data source 104a, a data source 104b, and a data source 104c). Examples of the plurality of data sources 104 may include, but are not limited to relational databases, Enterprise Resource Planning (ERP) systems, purchased data, or legacy data. In other words, the plurality of data sources 104 include heterogeneous data that may be accessed by data management device 102.

Data management device 102 may be communicatively coupled to plurality of data sources 104 via a network 106. Network 106 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS). Thus, data management device 102 may receive heterogeneous data from plurality of data sources 104 via network 106. The heterogeneous data may include structured and unstructured data or a combination thereof.

Data management device 102, thereafter, may analyze the heterogeneous data in order to store and manage the heterogeneous data in a plurality of data clouds 108 (which includes, a data cloud 108a, a data cloud 108b, a data cloud 108c, and a data cloud 108d). Each of plurality of data clouds 108 may be divided into a structured section and an unstructured section. The structured section within each of plurality of data clouds 108 is used to store structured data, while the unstructured section within each of plurality of data clouds 108 is used to store unstructured data. Examples of structured data may include, but are not limited to text in various formats. Examples of unstructured data may include, but are not limited to images, audio files, or video files.

Data management device 102 may be communicatively coupled to plurality of data clouds 108 via network 106. To this end, data management device 102 may include a processor 110 that is communicatively coupled to a memory 112, which may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM), and Static Random-Access memory (SRAM).

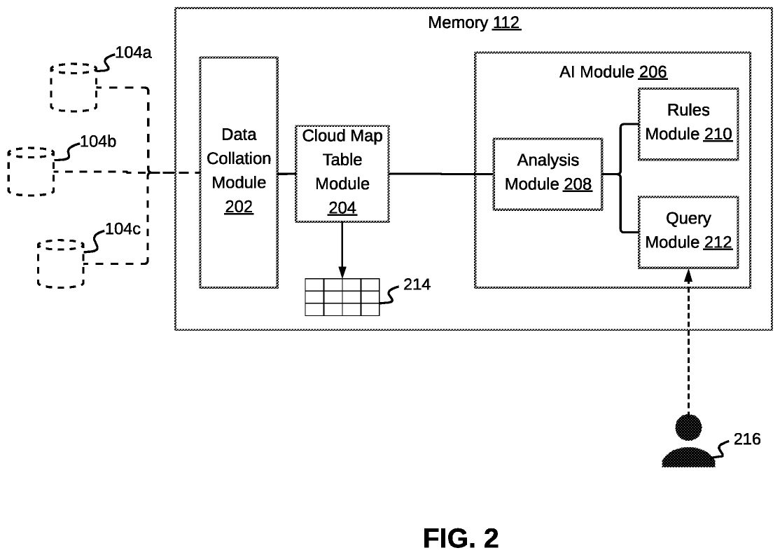

Memory 112 further includes various modules that enable data management device 102 to manage and store heterogeneous data received from plurality of data sources 104 in plurality of data clouds 108. These modules are explained in detail in conjunction with FIG. 2. Data management device 102 may further include a display 114 having a User Interface (UI) 116 that may be used by a user or an administrator to provide various inputs to data management device 102. Display 114 may further be used to display a result of the analysis performed by data management device 102.

Referring now to FIG. 2, a block diagram of various modules within memory 112 of data management device 102 configured to manage Big-Data in a cloud environment, in accordance with an embodiment. Memory 112 includes a data collation module 202, a cloud map table module 204, and an Artificial Intelligence (AI) module 206 that further includes an analysis module 208, a rules module 210, and a query module 212.

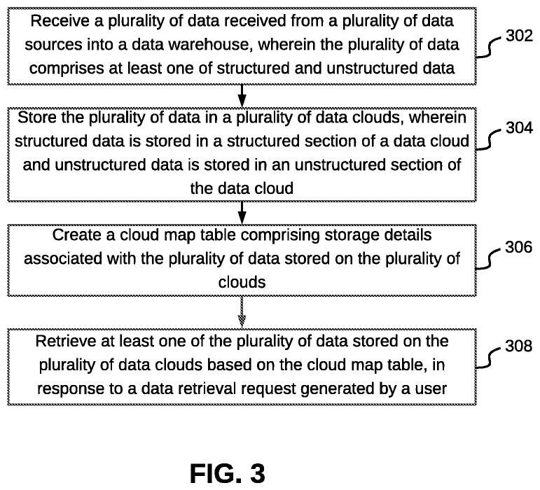

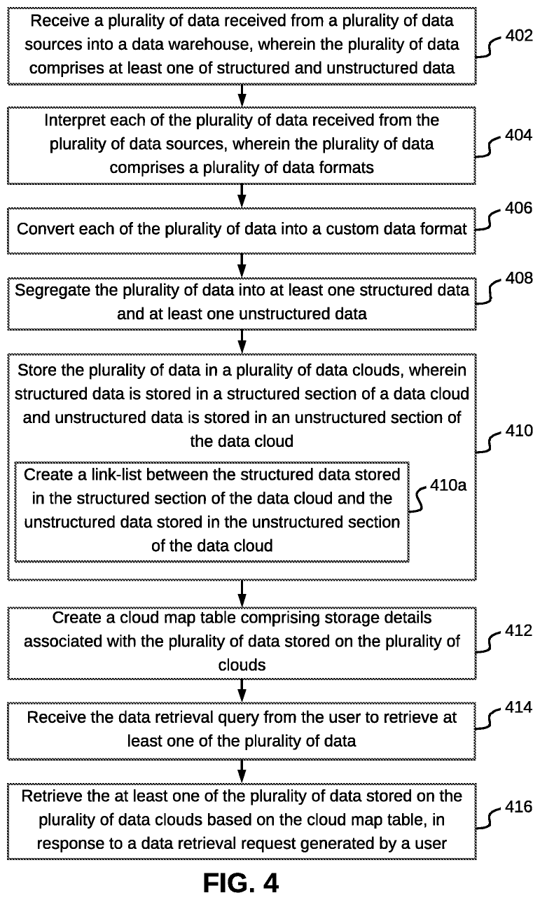

Data collation module 202 acts as a data warehouse and receives a plurality of data from plurality of data sources 104 and thereafter collates the same. The plurality of data is heterogeneous and may include one or more of structured and unstructured data. Data collation module 202 determines whether each of the plurality of data is structured, unstructured, or a combination of structured and unstructured data. Data collation module 202 may then convert each of the plurality of data into a custom data format. Thereafter, data collation module 202 segregates the plurality of data into structured data and unstructured data. This has been explained in detail in conjunction with FIG. 3 and FIG. 4.

Cloud map table module 204 then stores the plurality of data in plurality of data clouds 108. As each of plurality of data clouds 108 include structured section for structured data and unstructured section for unstructured data, structured data segregated from the plurality of data is stored in structured sections of one or more of plurality of data clouds 108 and unstructured data segregated from the plurality of data is stored in unstructured sections of one or more of plurality of data clouds 108. This is further explained in detail in conjunction with FIG. 3 and FIG. 4. While storing the plurality of data, cloud map table module 204 creates a cloud map table 214 that includes storage details associated with the plurality of data stored on plurality of data clouds 108. For a particular data stored in a data cloud, the storage details in cloud map table 214 includes one or more of: frame number storing the data, a cloud number storing the data, offset address in the data cloud storing the data, or an indication regarding the data being structured or unstructured. This is further explained in detail in conjunction with FIG. 3 and FIG. 4.

AI module 206 facilitates in decision making by providing recommendations and predictions based on data retrieved using cloud map table 214 and based on learning so derived. AI module 206 also determines effectiveness of data that is retrieved from one or more of plurality of data clouds 108 in response to data retrieval query received from a user. The data so retrieved may be used for incremental learning by AI module 206. When a data retrieval query is received from a user, AI module 206 analyze all historic decisions that were taken in the past in order to determine the most beneficial decisions.

AI module 206 further includes query module 210 that receives a data retrieval query from a user 216 to retrieve one or more of the plurality of data from plurality of data clouds 108. Query Module 210 is configured to process highly complex data retrieval queries, such that, multiple data points may be requested by a user in a single data retrieval query. Based on the contents of the data retrieval query (for example, complexity), the data retrieval query is further analyzed and sent to rules module 210. Rules module 210 maps the data retrieval query to a set of predefined data retrieval rules for further analysis. Based on the mapping to the set of predefined data retrieval rules, analysis module 208 maps the data retrieval query to cloud map table 214 in order to retrieve relevant data from one or more of plurality of data clouds 108. Cloud map table module 204 then retrieves one or more of the plurality of data stored on plurality of data clouds 108 based on the mapping performed by analysis module 208. Analysis module 208 further analyzes the data so retrieved to determine effectiveness or relevancy of the data. This is further explained in detail in conjunction with FIG. 3.

Referring now to FIG. 3, a flowchart of a method for managing Big-Data in a cloud environment is illustrated, in accordance with an embodiment. At step 302, data management device 102 receives a plurality of data from plurality of data sources 104 into data collation module 202, that acts as a data warehouse. Data received from the plurality of data sources 104 may either be structured or unstructured. Alternatively, the data received from the plurality of data sources 104 may be a combination of structured or unstructured data. Examples of structured data may include, but are not limited to text in various formats. Examples of unstructured data may include, but are not limited to images, audio files, or video files.

Data collation module 202 interprets each of the plurality of data received from plurality of data sources 104. The plurality of data may include a plurality of data formats. Thereafter, data collation module 202 converts each of the plurality of data into a custom data format for data consistency. Once the plurality of data is converted into the custom data format, data management device 102 may then segregate the plurality of data into structured data and unstructured data. This is further explained in detail in conjunction with FIG. 4.

After the plurality of data is received and converted into the custom data format, data management device 102, at step 304, stores the plurality of data in plurality of data clouds 108. Each of plurality of data clouds 108 may be divided into a structured section and an unstructured section. The structured section within each of plurality of data clouds 108 is used to store structured data, while the unstructured section within each of plurality of data clouds 108 is used to store unstructured data. Structured data may be stored in either Multi Relational Database (MRDB) or Multidimensional Database (MDDB). Unstructured data may be stored in any schema. In other words, the schema may be made in accordance with the need.

Data management device 102, at step 306, creates a cloud map table that includes storage details associated with the plurality of data stored on plurality of data clouds 108. The cloud map table may be a data structure that includes address or location for each of the plurality of data as stored in one or more of plurality of data clouds 108.

The cloud map table enables storage of data in a very efficient manner for the use in various Big-Data processing in a cloud environment, allows management of data using a customized data structure, by splitting data in terms of type, i.e., structured or unstructured, present users with an interface in which data can be viewed in multiple dimensions, improves data retrieval and processing rate, i.e., improved agility, makes full use of cloud environment for cheaper resources, and provides improvement in Big-Data processing on various fronts, for example, but not limited to data visualization, cost, ease of use, security, query support, and network intrusion.

Additionally, the cloud map table enables storage of data in a cloud environment. As the data structure of the cloud map table is very well managed, data that needs to be processed can be easily located using the cloud map table. Moreover, as a result of the cloud map table the data stored in the cloud environment can be visualized in a very efficient manner. The cloud map table also enables better query support, secure transactions, ease of use, and is highly scalable with minimal cost.

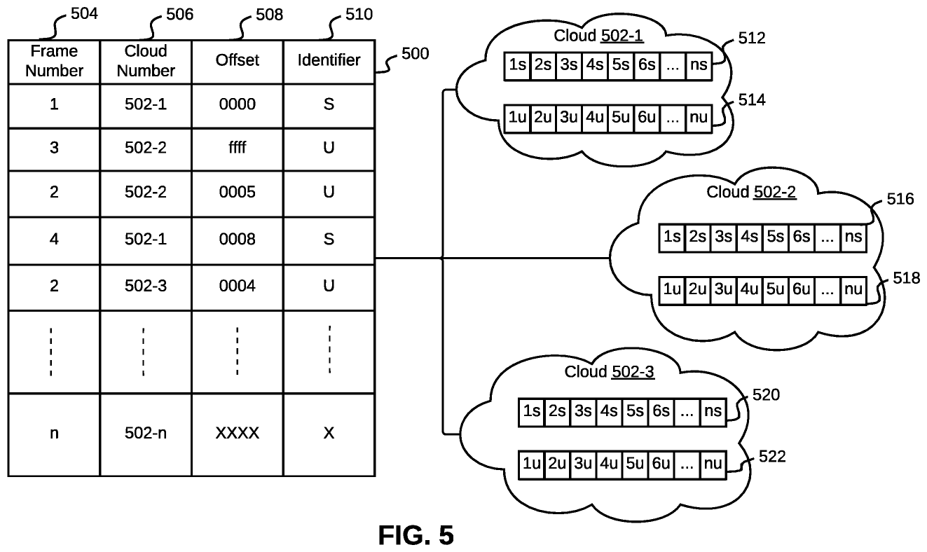

In an exemplary embodiment, the cloud map table may include four columns. The first column may include “frame number” for the frame that stores a particular data. The second column may include the cloud number or the address of the data cloud in which the particular data is stored. In other words, the second column may include information related to storage location for the particular data. The third column may include offset information from a base address, for the particular data stored in the data cloud. This offset information facilitates in locating the specific frame in which the particular data is stored. The fourth column may include an identifier that is used to identify whether a specific piece of data is structured or unstructured data. The cloud map table is further explained in detail in conjunction with an exemplary embodiment given in FIG. 5. The cloud map table helps is providing a multi-dimensional view of the data that is stored on one or more of plurality of data clouds 108. This enables, easy retrieval of accurate data when requested by a user.

In response to a data retrieval query generated by a user, data management device 102, based on the cloud map table, retrieves one or more of the plurality of data stored on plurality of data clouds 108, at step 308. In an embodiment, after being received, a data retrieval query is processed to determine multiple data points that have been requested through the data retrieval query. The data retrieval query is then mapped to a set of predefined data retrieval rules. Thereafter, the data retrieval query after being mapped is further matched with the cloud map table in order to retrieve data from one or more of plurality of data clouds 108. The retrieved data may then be further analyzed in order to determine effectiveness of the retrieved data. In an embodiment, in order to determine effectiveness of the data, a score may be automatically provided by AI module 206 to the retrieved data.

By way of an example, if the retrieved data gets a positive score, then retrieved data is accurate. Thus, the mapping of the data retrieval query to the set of data retrieval rules and subsequently to the cloud map table is determined to be correct. On the contrary, if the retrieved data gets a negative score, then retrieved data is inaccurate. Thus, the mapping of the data retrieval query to the set of data retrieval rules and subsequently to the cloud map table is determined to be incorrect. By way of another example, if the retrieved data gets a neutral score, human interpretation of the retrieved data may be required.

Referring now to FIG. 4, a flowchart of a method for managing Big-Data in a cloud environment is illustrated, in accordance with another embodiment. At step 402, a plurality of data received from a plurality of data sources may be received into data collation module 202 that acts as a data warehouse. The plurality of data may include one or more of structured and unstructured data. At step 404, each of the plurality of data received from the plurality of data sources is interpreted. In other words, it is determined whether the data is structured, unstructured, or a combination of structured and unstructured data. Examples of a combination of structured and unstructured data may include, but are not limited to a video with captions or an audio file with textual details (for example, name of the lyricist, singer, etc). The plurality of data may include a plurality of data formats. In this case, interpretation of data may include determining native formats for each of the plurality of data.

Thereafter, at step 406, each of the plurality of data is converted into a custom data format. The custom data format may be determined by an administrator. As, in step 404, native formats for each of the plurality of data are determined, they are converted into the custom data format. Conversion of each of the plurality of data into a uniform and custom data format facilitates performance of further analysis on the plurality of data.

Once the plurality of data is converted into the custom data format, the plurality of data is segregated into structured data and unstructured data at step 408. Thus, structured and unstructured data are now available in the custom data format. Thereafter, at step 410, the plurality of data is stored in plurality of data clouds 108. As each of plurality of data clouds 108 include structured section for structured data and unstructured section for unstructured data, structured data segregated from the plurality of data is stored in structured sections of one or more of plurality of data clouds 108 and unstructured data segregated from the plurality of data is stored in unstructured sections of one or more of plurality of data clouds 108. This is further explained in detail in conjunction with FIG. 5.

In an embodiment, when data is combination of structured and unstructured data, the structured part of the data in stored in structured section of a data cloud, while unstructured part of the data is stored in unstructured section of the data cloud. In this case, a link-list is created between the structured data stored in the structured section of the data cloud and the unstructured data stored in the unstructured section of the data cloud. The link-list enables simultaneous extraction of the structured data and the unstructured data in response to a data retrieval query. By way of an example, a video with captions may be segregated into a video (unstructured data) and captions (structured data). The video may be stored in the unstructured section of a data cloud, while the captions may be stored in the structured sections of the data cloud. A link-list may then be created between the video and the caption.

At step 412, a cloud map table is created, such that, the cloud map table includes storage details associated with the plurality of data stored on plurality of data clouds 108. For a particular data stored in a data cloud, the storage details in the cloud map table includes one or more of: frame number storing the data, a cloud number storing the data, offset address in the data cloud storing the data, or an indication regarding the data being structured or unstructured.

At step 414, a data retrieval query is received from a user to retrieve one or more of the plurality of data from plurality of data cloud. Based on the contents of the data retrieval query (for example, complexity), the data retrieval query is further analyzed. The data retrieval query is mapped to the set of predefined data retrieval rules and is then mapped to the cloud map table. This has already been explained in detail in conjunction with FIG. 3.

In response to the data retrieval query, one or more of the plurality of data stored on plurality of data clouds 108 is retrieved based on the cloud map table at step 416. The one or more columns in the cloud map table are then used to determine the data (structure, unstructured, or a combination thereof) that is to be retrieved from one or more of plurality of data clouds 108 based on the data retrieval query. By way of an example, the data may be retrieved by utilizing the “unique identifier” and “frame offset” in the cloud map table. The data thus retrieved is multi-dimensional in its representation. In an embodiment, once the data is retrieved, effectiveness of the retrieved data is determined based on a score provided to the retrieved data. This has already been explained in detail in conjunction with FIG. 3.

Referring now to FIG. 5, a cloud map table 500 storing address for data stored in a plurality of data clouds 502 is illustrated, in accordance with an exemplary embodiment. Each of plurality of data clouds 502 (which include a data cloud 502-1, a data cloud 502-2, and a data cloud 502-3) include a structured section to store structured data and an unstructured data to store unstructured data. For example, data cloud 502-1 includes a structured section 512 and an unstructured section 514, data cloud 502-2 includes a structured section 516 and an unstructured section 518, and data cloud 502-3 includes a structured section 520 and an unstructured section 522. Each of the structured and unstructured sections include a plurality of frames. By way of an example, structured section 512 includes “n” number of frame that are numbered from “1 to n.” Similarly, unstructured section 514 also includes “n” number of frame that are numbered from “1 to n.”

When plurality of data is stored in one or more of plurality of data clouds 502, location of each of the plurality of data is stored in cloud map table 500. Data map table 500 includes a frame number column 504, a cloud number column 506, an offset column 508, and an identifier column 510. Frame number column 504 may include the frame number in which a particular data is stored, cloud number column 506 includes the number of the data cloud where the particular data is stored, offset column 508 specifies the offset or displacement of the particular data from the base address in the data cloud, which is used to locate the particular frame, and identifier column 510 identifies whether the data stored in structured or unstructured by using the letter ‘U’ for unstructured data and “S” for structured data. Cloud map table 500 thus stores the plurality of data in a multi-dimensional view. This enables accurate and efficient retrieval of relevant data from one or more of plurality of data clouds 502, in response to a data retrieval query received from a user.

By way of an example, the first row in cloud map table 500 indicates that structured data is stored in frame number 1 of data cloud 502-1 and is offset by ‘0000” from the based address in data cloud 502-1. By way of another example, the second row in cloud map table 500 indicates that unstructured data is stored in frame number 3 of data cloud 502-2 and is offset by ‘ffff” from the based address in data cloud 502-2.

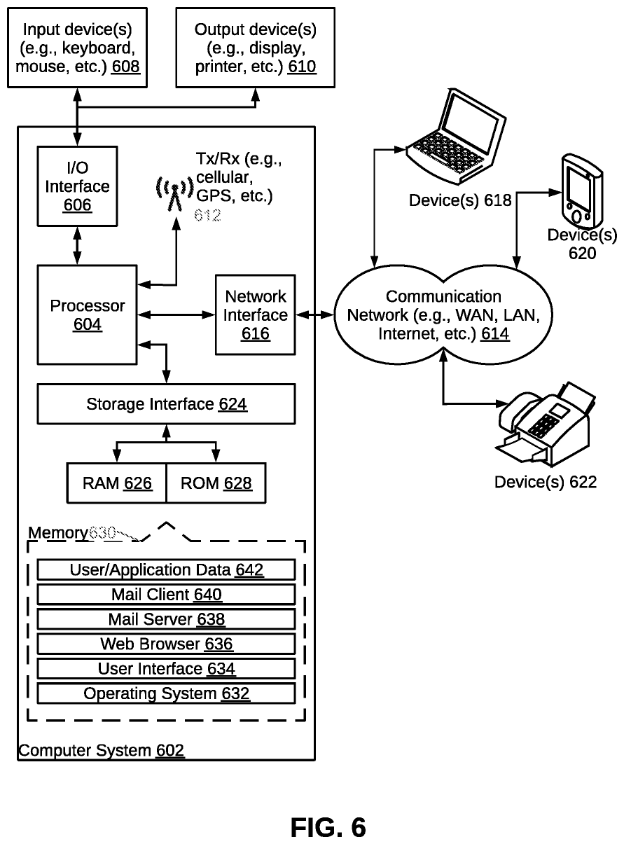

FIG. 6 is a block diagram of an exemplary computer system for implementing various embodiments. Computer system 602 may include a central processing unit (“CPU” or “processor”) 604. Processor 604 may include at least one data processor for executing program components for executing user- or system-generated requests. A user may include a person, a person using a device such as such as those included in this disclosure, or such a device itself. Processor 604 may include specialized processing units such as integrated system (bus) controllers, memory management control units, floating point units, graphics processing units, digital signal processing units, etc. Processor 604 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 604 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 604 may be disposed in communication with one or more input/output (I/O) devices via an I/0 interface 606. I/O interface 606 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 606, computer system 602 may communicate with one or more I/O devices. For example, an input device 608 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 610 may be a printer, fax machine, video display (e.g., cathode ray tube (CRT), liquid crystal display (LCD), light-emitting diode (LED), plasma, or the like), audio speaker, etc. In some embodiments, a transceiver 612 may be disposed in connection with processor 604. Transceiver 612 may facilitate various types of wireless transmission or reception. For example, transceiver 612 may include an antenna operatively connected to a transceiver chip (e.g., TEXAS® INSTRUMENTS WILINK WL1283® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 604 may be disposed in communication with a communication network 614 via a network interface 616. Network interface 616 may communicate with communication network 614. Network interface 616 may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc. Communication network 614 may include, without limitation, a direct interconnection, local area network (LAN), wide area network (WAN), wireless network (e.g., using Wireless Application Protocol), the Internet, etc. Using network interface 616 and communication network 614, computer system 602 may communicate with devices 618, 620, and 622. These devices may include, without limitation, personal computer(s), server(s), fax machines, printers, scanners, various mobile devices such as cellular telephones, smartphones (e.g., APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 602 may itself embody one or more of these devices.

In some embodiments, processor 604 may be disposed in communication with one or more memory devices (e.g., RAM 626, ROM 628, etc.) via a storage interface 624. Storage interface 624 may connect to memory 630 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 630 may store a collection of program or database components, including, without limitation, an operating system 632, user interface application 634, web browser 636, mail server 638, mail client 640, user/application data 642 (e.g., any data variables or data records discussed in this disclosure), etc. Operating system 632 may facilitate resource management and operation of computer system 602. Examples of operating systems 632 include, without limitation, APPLE® MACINTOSH® OS X platform, UNIX platform, Unix-like system distributions (e.g., Berkeley Software Distribution (BSD), FreeBSD, NetBSD, OpenBSD, etc.), LINUX distributions (e.g., RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 634 may facilitate display, execution, interaction, manipulation, or operation of program components through textual or graphical facilities. For example, user interfaces may provide computer interaction interface elements on a display system operatively connected to computer system 602, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (e.g., AERO® platform, METRO® platform, etc.), UNIX X-WINDOWS, web interface libraries (e.g., ACTIVEX® platform, JAVA® programming language, JAVASCRIPT® programming language, AJAX® programming language, HTML, ADOBE® FLASH® platform, etc.), or the like.

In some embodiments, computer system 602 may implement a web browser 636 stored program component. Web browser 636 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 602 may implement a mail server 638 stored program component. Mail server 638 may be an Internet mail server such as MICROSOFT® EXCHANGE® mail server, or the like. Mail server 638 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 638 may utilize communication protocols such as internet message access protocol (IMAP), messaging application programming interface (MAPI), Microsoft Exchange, post office protocol (POP), simple mail transfer protocol (SMTP), or the like. In some embodiments, computer system 602 may implement a mail client 640 stored program component. Mail client 640 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 602 may store user/application data 642, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (e.g., XML), table, or as object-oriented databases (e.g., using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments with reference to different functional units and processors. However, it will be apparent that any suitable distribution of functionality between different functional units, processors or domains may be used without detracting from the technology. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments provide methods and devices for managing Big-Data in cloud environments. The method uses a cloud map table to store and manage data in the cloud environment. As a result of the cloud map table, data management in the cloud environment becomes efficient as both structured and unstructured data are put and sorted in a predefined order in multiple clouds. Each of the multiple clouds are divided into multiple frames that hold both structured and unstructured data. As the cloud map table includes details regarding location of the data in the multiple clouds, the cloud map table is used to efficiently retrieve accurate and relevant data. Implementing data warehouse using the cloud map table and the cloud environment gives multidimensional view to the stored data. This enables data mining to be performed using existing technologies and data agility becomes achievable. The method thus provides a cost effective, reliable, accurate, easy to use, and agile solution for managing Big-Data.

The claimed steps as discussed above are not routine, conventional, or well understood in the art, as the claimed steps enable the following solutions to the existing problems in conventional technologies. Data storage is a problem with existing technologies, but the cloud map table enables storage of data perfectly and in an organized manner in the clouds, as a result, the data storage problems in the existing technologies is solved. Use of cloud map table also increases fault tolerance, as data can be made redundant with proper data management, which further makes data retrieval very easy and effective. Moreover, as the data is more organized because of the cloud map table, better data virtualization is provided due to multidimensionality of data storage. This further enables deep drilling into the data, thereby making data mining an easy job using existing technologies.

Also, queries can be carried out in split execution which will give the efficient results. Complex queries can be split and better results can be attained. Decision making is performed by an AI module after receiving a data retrieval query from a user query, which then maps the data retrieval query to a cloud map table based on a set of predefined data retrieval rules. The data retrieved from one or more data clouds is then analyzed by the AI module to determines effectiveness of the retrieved data. Based on this analysis, the AI module also performs incremental learning based for future analysis.

The specification has described method and device for managing Big-Data in cloud environment. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for managing Big-Data in a cloud environment, the method implemented by one or more data management devices and comprising:
receiving data from a plurality of data sources into a data warehouse, wherein the data comprises at least one of structured or unstructured data;
storing the data in a plurality of data clouds, wherein each of the data clouds is divided into a structured section and an unstructured section, wherein structured data is stored in the structured section and unstructured data is stored in the unstructured section;
creating a cloud map table comprising storage details associated with the data stored on the data clouds; and
retrieving at least a portion of the data stored on one or more of the data clouds based on the cloud map table, in response to a received data retrieval query.

2. The method of claim 1, further comprising:
interpreting the data received from the data sources, wherein the data comprises a plurality of data formats; and
converting the data into a custom data format.

3. The method of claim 1, further comprising segregating the data into structured data or unstructured data.

4. The method of claim 1, further comprising creating a link-list between the structured data stored in the structured section and the unstructured data stored in the unstructured section, wherein the structured data and the unstructured data are extracted from one or more portions of the data and the link-list enables simultaneous extraction of the structured data and the unstructured data in response to the data retrieval query.

5. The method of claim 1, wherein:
for data stored in one of the data clouds, the storage details in the cloud map table comprise at least one of frame number storing the data, a cloud number storing the data, an offset address in the one of the data clouds, or an indication regarding the data being structured or unstructured; and
the at least a portion of the data is retrieved based on the storage details in the cloud map table.

6. The method of claim 1, wherein the data sources comprise at least one of one or more relational databases, Enterprise Resource Planning (ERP) systems, purchased data, or legacy data and the data sources are communicatively coupled with the data warehouse.

7. A data management device, comprising a processor and a memory communicatively coupled to the processor, wherein the memory stores processor instructions, which, on execution by the processor, causes the processor to:
receive data from a plurality of data sources into a data warehouse, wherein the data comprises at least one of structured or unstructured data;
store the data in a plurality of data clouds, wherein each of the data clouds is divided into a structured section and an unstructured section, wherein structured data is stored in the structured section and unstructured data is stored in the unstructured section;
create a cloud map table comprising storage details associated with the data stored on the data clouds; and
retrieve at least a portion of the data stored on one or more of the data clouds based on the cloud map table, in response to a received data retrieval query.

8. The data management device of claim 7, wherein, on execution by the processor, the processor instructions further cause the processor to:
interpret the data received from the data sources, wherein the data comprises a plurality of data formats; and
convert the data into a custom data format.

9. The data management device of claim 7, wherein, on execution by the processor, the processor instructions further cause the processor to segregate the data into structured data or unstructured data.

10. The data management device of claim 7, wherein, on execution by the processor, the processor instructions further cause the processor to create a link-list between the structured data stored in the structured section and the unstructured data stored in the unstructured section, wherein the structured data and the unstructured data are extracted from one or more portions of the data and the link-list enables simultaneous extraction of the structured data and the unstructured data in response to the data retrieval query.

11. The data management device of claim 7, wherein:
for data stored in one of the data clouds, the storage details in the cloud map table comprise at least one of frame number storing the data, a cloud number storing the data, an offset address in the one of the data clouds, or an indication regarding the data being structured or unstructured; and
the at least a portion of the data is retrieved based on the storage details in the cloud map table.

12. The data management device of claim 7, wherein the data sources comprise at least one of one or more relational databases, Enterprise Resource Planning (ERP) systems, purchased data, or legacy data and the data sources are communicatively coupled with the data warehouse.

13. A non-transitory computer-readable storage medium comprising a set of computer-executable instructions stored thereon causing a computer comprising one or more processors to:
receive data from a plurality of data sources into a data warehouse, wherein the data comprises at least one of structured or unstructured data;
store the data in a plurality of data clouds, wherein each of the data clouds is divided into a structured section and an unstructured section, wherein structured data is stored in the structured section and unstructured data is stored in the unstructured section;
create a cloud map table comprising storage details associated with the data stored on the data clouds; and
retrieve at least a portion of the data stored on one or more of the data clouds based on the cloud map table, in response to a received data retrieval query.

14. The non-transitory computer-readable storage medium of claim 13, wherein the computer-executable instructions further cause the computer comprising the processors to:
interpret the data received from the data sources, wherein the data comprises a plurality of data formats; and
convert the data into a custom data format.

15. The non-transitory computer-readable storage medium of claim 13, wherein the computer-executable instructions further cause the computer comprising the processors to segregate the data into structured data or unstructured data.

16. The non-transitory computer-readable storage medium of claim 13, wherein the computer-executable instructions further cause the computer comprising the processors to create a link-list between the structured data stored in the structured section and the unstructured data stored in the unstructured section, wherein the structured data and the unstructured data are extracted from one or more portions of the data and the link-list enables simultaneous extraction of the structured data and the unstructured data in response to the data retrieval query.

17. The non-transitory computer-readable storage medium of claim 13, wherein:
for data stored in one of the data clouds, the storage details in the cloud map table comprise at least one of frame number storing the data, a cloud number storing the data, an offset address in the one of the data clouds, or an indication regarding the data being structured or unstructured; and
the at least a portion of the data is retrieved based on the storage details in the cloud map table.

18. The non-transitory computer-readable storage medium of claim 13, wherein the data sources comprise at least one of one or more relational databases, Enterprise Resource Planning (ERP) systems, purchased data, or legacy data and the data sources are communicatively coupled with the data warehouse.
